(19) United States
(12) Patent Application Publication
(10) Pub. No.: US 2023/0003594 A1
(43) Pub. Date: Jan. 5, 2023

(54) Winch Testing Device, Forestry Equipment With a Forestry Winch, System and Method for Testing the Winch Pulling Capacity and Brake Holding Capacity of a Forestry Winch

(71) Applicant: Bernward Welschof, Grossostheim (DE)

(72) Inventors: Michael Willenbücher, Oberzent (DE); Claus Hofmann, Haibach (DE); Bernward Welschof, Grossostheim (DE)

(21) Appl. No.: 17/852,488

(22) Filed: Jun. 29, 2022

(30) Foreign Application Priority Data
Jun. 30, 2021 (DE) 10 2021 116 863.5

(51) Int. Cl. G01L 5/00; G01L 5/28

(52) U.S. Cl. CPC G01L 5/0033; G01L 5/0061; G01L 5/28

(57) ABSTRACT

A winch testing device for testing the winch pulling capacity and brake holding capacity of a forestry winch of forestry equipment, in particular of a mobile forestry machine or an accessory rear shield, wherein the forestry winch has a rope drum that can be driven by a drive motor and braked by means of a brake device and on which a rope is spooled. The winch test device has a hydraulic test cylinder which has a first attachment interface, with which the hydraulic test cylinder can be fastened to an attachment point of the forestry equipment, and a second attachment interface with which the hydraulic test cylinder can be connected with the rope of the forestry winch.

### CROSS REFERENCE TO RELATED APPLICATIONS

This application claims priority to German Patent Application Nos. 10 2021 116 863.5 filed Jun. 30, 2021, the disclosure of which is hereby incorporated by reference in its entirety.

### BACKGROUND OF THE INVENTION

### Field of the Invention

This disclosure relates to a winch testing device for testing the winch pulling capacity and the brake holding capacity of a forestry winch of forestry equipment, in particular of a mobile forestry machine or an accessory rear shield, wherein the forestry winch has a rope drum that can be driven by a drive motor and braked by means of a brake device, and on which a rope is spooled.

The disclosure further relates to a forestry equipment, in particular a mobile forestry machine or an accessory rear shield, with a forestry winch, wherein the forestry winch has a rope drum that can be driven by a drive motor and braked by means of a brake device, and on which a rope is spooled, wherein the rope is guided from the rope drum to an ejector roller located on the forestry equipment and is guided over the ejector roller.

The disclosure further relates to a system including forestry equipment, in particular a mobile forestry machine or an accessory rear shield, with a forestry winch, wherein the forestry winch has a rope drum that can be driven by a drive motor and braked by means of a brake device, and on which a rope is spooled, wherein the rope is guided from the rope drum to an ejector roller located on the forestry equipment and is guided over the ejector roller, and a winch testing device to test the winch pulling capacity and the brake holding capacity of the forestry winch of the forestry equipment.

The disclosure further relates to a method for testing the winch pulling capacity and the brake holding capacity of a forestry winch of a system of this type.

### Description of Related Art

Forestry winches represent equipment that require testing, and for which an annual recurring test of the maximum winch pulling capacity and brake holding capacity is required, for example to comply with occupational safety regulations. For this recurring annual test, the maximum winch pulling capacity of the forestry winch and the brake holding capacity of the braking device of the forestry winch must be determined, and it must be verified that the brake holding capacity is at least 125% of the maximum winch pulling capacity. The brake holding capacity is considered the force exerted by the rope that results in the slipping of the brake device in the braking position.

Test stands designed and constructed for this purpose are known for the testing of the maximum winch pulling capacity and brake holding capacity of forestry winches in the form of 3-point rear-shield winches which are attached as an accessory device to tractors. A 3-point rear-shield winch is an accessory rear shield for attachment to a 3-point power lift of a tractor that is equipped with a forestry winch. Corresponding test stands for the testing of forestry equipment in the form of 3-point rear shield winches are known from DE 10 2014 117 956 B3 and DE 10 2018 125 131 B4. The test stands known from DE 10 2014 117 956 B3 and DE 10 2018 125 131 B4 have a frame supported on the ground in which a hydraulic test cylinder is installed and on which the 3-point rear shield winch to be tested is supported on a stop. Test stands of this type have a complex construction, large dimensions and are therefore mobile only to a limited extent, so that the 3-point rear shield winches, the maximum winch pulling capacity and brake holding capacity of which is to be tested, must be brought to the test stand. The test stands known from DE 10 2014 117 956 B3 and DE 10 2018 125 131 B4 are also designed for 3-point rear shield winches and cannot be used for the testing a forestry winch when it is installed in a mobile forestry machine. Additionally, with test stands of this type, the introduction of force and the support of the test stand on the foundation are not optimal. The test stands known from DE 10 2014 117 956 B3 and DE 10 2018 125 131 B4 are designed so that the 3-point rear shield winch is supported on the stop on the test stand and the test stand pulls against the rear shield until there is a positive engagement between the rear shield and the stop on the test stand. On these known test stands, the hydraulic test cylinder is also not optimally oriented with reference to the flow of forces, and during the performance of the test to test the maximum winch pulling capacity and the brake holding capacity, the test stand is subjected to torque. As a result of this torque, the frame of the test stand buckles and can lift up off the ground. When the force of the rope is relieved as the brake device is opened, the components of the test stand that bear the load generated by the torque strike the ground, as a result of which there are high loads on the test stand and unpleasant noises.

### SUMMARY OF THE INVENTION

The object of this disclosure is to make available a winch testing device and a method for testing the winch pulling capacity and the brake holding capacity of a forestry winch with which, in a simple manner, it becomes possible to conduct a test of the forestry winch while it is installed in the forestry equipment.

According to this disclosure, this object is accomplished in that the winch test device has a hydraulic test cylinder which has a first attachment interface with which the hydraulic test cylinder can be fastened to an attachment point of the forestry equipment and a second attachment interface with which the hydraulic test cylinder can be connected with the rope of the forestry winch.

The disclosure therefore teaches that on forestry equipment such as mobile forestry machines or accessory rear shields, for example, with an installed forestry winch, the testing of the maximum winch pulling capacity and the brake holding capacity can be performed directly on the forestry equipment and thus internally, for example on a mobile forestry machine, when the winch is installed on the vehicle, if the hydraulic test cylinder is fastened with a first attachment interface to an attachment point of the forestry equipment. The winch testing device therefore includes essentially only the hydraulic test cylinder and no longer requires a heavy, bulky frame. A compact and therefore mobile winch testing device of this type can be brought in a simple manner to the forestry winch to be tested and thus to the forestry equipment, for example a mobile forestry machine or an accessory rear shield, to perform a test of the maximum winch pulling capacity and brake holding capacity of the forestry winch while it is still installed on the forestry equipment. Compared to test stands of the prior art, the testing device according to the disclosure also has an improved flow of forces, because during the performance of the test the rope forces are introduced directly into the hydraulic cylinder, so that when the brake device is opened, there are only low loads on the winch testing device and no unpleasant noises are generated.

According to one advantageous configuration of the disclosure, the first attachment interface is a mounting flange of a bolted joint on the hydraulic test cylinder. For this purpose the mounting flange can preferably have one or more mounting flange plates, each of which has a boring to receive an attachment bolt. With an attachment interface of this type, the hydraulic test cylinder can be quickly and easily fastened to a corresponding attachment point of the forestry equipment for the testing of the maximum winch pulling capacity and the brake holding capacity. If the attachment point of the forestry equipment is already provided for other components, such as the attachment point of a linkage for a heavy-duty roller, the components already present can be used for the attachment of the hydraulic test cylinder to the forestry equipment and are preferably designed to withstand the operational forces generated by the forestry winch.

According to one preferred configuration of the disclosure, the second attachment interface is a rope attachment roller located on the hydraulic test cylinder. On a rope attachment roller such as a wrapping knob, for example, around which the rope can be wrapped a plurality of times, for example at least three turns, the hydraulic test cylinder can be quickly and easily connected with the rope and the rope forces necessary to test the maximum winch pulling capacity and brake holding capacity can be transmitted.

According to one advantageous embodiment of the disclosure, the hydraulic test cylinder has a cylinder casing and a piston rod located so that it can slide inside the cylinder casing, wherein the first attachment interface is located on the piston rod and the second attachment interface is located on the cylinder casing. A hydraulic test cylinder of this type has a simple construction.

The winch testing device advantageously has a pressure measurement device with which the pressure in a pressure chamber formed between the cylinder casing and the piston rod can be measured. With a pressure measurement device of this type, the pressure in the pressure chamber can be measured easily, and for the testing of the forestry winch, the maximum winch pulling capacity and brake holding capacity can be determined directly or indirectly from the pressure in the pressure chamber. The pressure measurement device is preferably an electronic pressure measurement device that transmits the measurement data to an evaluation computer in which the pressures measured during the testing of the maximum winch pulling capacity and brake holding capacity are recorded and documented.

According to one advantageous development of the disclosure, the winch testing device includes a hydraulic pump by means of which the pressure chamber can be pressurized. With the hydraulic pump, as a result of a pressurization of the pressure chamber, a tractive force to test the brake holding capacity can easily be applied to the rope connected with the hydraulic test cylinder.

According to one advantageous embodiment of the disclosure, the hydraulic pump is a manually operable hand pump. This results in a further simplification of the construction of the hydraulic test cylinder and makes it possible to test the forestry winch in forestry equipment in the field, where there is no electric power connection for an electrically operated pump unit.

The disclosure teaches that this object is accomplished, with reference to forestry equipment, in particular a mobile forestry machine or an accessory rear shield with a forestry winch, wherein the forestry winch has a rope drum that can be driven by a drive motor and braked by means of a brake device, and on which a rope is spooled, wherein the rope is guided from the rope drum to an ejector roller located on the forestry equipment and is guided over the ejector roller, in that the forestry equipment is provided with an attachment point to which the hydraulic test cylinder of the winch testing device can be attached. The hydraulic test cylinder can be quickly and easily fastened to a corresponding attachment point of the forestry equipment to test the maximum winch pulling capacity and brake holding capacity, for example to perform the test while the winch is installed on the vehicle in a mobile forestry machine. If the attachment point of the forestry equipment is already provided for other components, such as the attachment point of a linkage for a heavy-duty roller, components that are already present can be used for the attachment of the hydraulic test cylinder to the forestry equipment and are preferably designed to withstand the for the operational forces generated by the forestry winch.

According to one preferred embodiment of the disclosure, the attachment point is located vertically underneath the ejector roller. The vertical distance between the ejector roller and the attachment point on the forestry equipment is preferably determined so that the hydraulic test cylinder with the rope attachment roller can be installed between the attachment point and the ejector roller of the forestry winch.

According to one preferred embodiment of the disclosure, the attachment point is a mounting flange of a bolted connection. For this purpose, the mounting flange can preferably have one or more mounting flange plates, each of which has a boring to receive an attachment bolt. The hydraulic test cylinder can be fastened quickly and easily by means of its mounting flange to an attachment point of this type in the form of a mounting flange to test the maximum winch pulling capacity and brake holding capacity on the forestry equipment, for example a mobile forestry machine or an accessory rear shield.

The disclosure further relates to a system comprising forestry equipment, in particular a mobile forestry machine or an accessory rear shield, with a forestry winch, wherein the forestry winch has a rope drum that can be driven by a drive motor and braked by means of a brake device, and on which a rope is wound up, wherein the rope is guided from the rope drum to an ejector roller located on the forestry equipment and is guided over the ejector roller, and a winch testing device to test the winch pulling capacity and the brake holding capacity of the forestry winch of the forestry equipment. According to the disclosure, this object is accomplished by a system of this type, in that the winch test device has a hydraulic test cylinder which has a first attachment interface, with which the hydraulic cylinder can be fastened to an attachment point of the forestry equipment, and a second attachment interface with which the hydraulic test cylinder can be connected with the rope of the forestry winch, and the forestry equipment is provided with an attachment point to which the hydraulic test cylinder of the winch testing device can be attached.

The object is accomplished with reference to a method for the testing of the winch pulling capacity and the brake holding capacity of a forestry winch of a system as described above by the following steps: attachment of the hydraulic test cylinder of the winch testing device with the first attachment interface to the attachment point of the forestry equipment, connection of the rope of the forestry winch with the second attachment interface of the hydraulic test cylinder of the winch testing device, and performance of the test of the winch pulling capacity and performance of the test of the brake holding capacity.

The hydraulic test cylinder is therefore fastened directly with the first attachment interface to the forestry equipment, for example a mobile forestry machine or an accessory rear shield, so that after the rope is connected with the second attachment interface of the hydraulic test cylinder, a test of the winch pulling capacity and brake holding capacity of the winch can be performed while the forestry winch is installed on the forestry equipment.

To test the winch pulling capacity, preferably the rope drum is operated in the rope spooling direction by means of the drive motor with the brake device in the release position and the maximum winch pulling capacity is determined by means of the winch testing device. A tractive force is therefore applied to the rope of the forestry winch by the drive motor, which can easily be determined with the pressure measurement device of the hydraulic test cylinder.

To test the brake holding capacity, with the brake device in the braking position, the brake holding force is preferably determined by actuating the hydraulic pump of the winch testing device. By activating the hydraulic pump, a tractive force can be applied to the rope of the forestry winch via the hydraulic test cylinder until the brake device slips, and the brake holding capacity of the braking device of the forestry winch can thereby be determined.

If, according to one development of the method, the determination of the brake holding capacity is performed a plurality of times, in particular 3 to 6 times, and an average value of the brake holding capacity is determined, fluctuations of the brake holding capacity can be minimized and the reliability of the measurement of the brake holding capacity can be increased.

### BRIEF DESCRIPTION OF THE DRAWINGS

Additional advantages and details of the disclosure are described in greater detail below with reference to the exemplary embodiments illustrated in the accompanying schematic figures, in which:

FIG. 1 is a perspective view of forestry equipment of a system according to the disclosure in the form of a mobile forestry machine,

FIG. 2 is a schematic illustration of a forestry winch of the forestry equipment in FIG. 1,

FIG. 3 is a sectional view of the forestry equipment in FIG. 1 with an installed winch testing device,

FIG. 4 is a schematic illustration of FIG. 3, and

FIG. 5 is a graph of the measured forces/pressures during a winch test.

### DESCRIPTION OF THE INVENTION

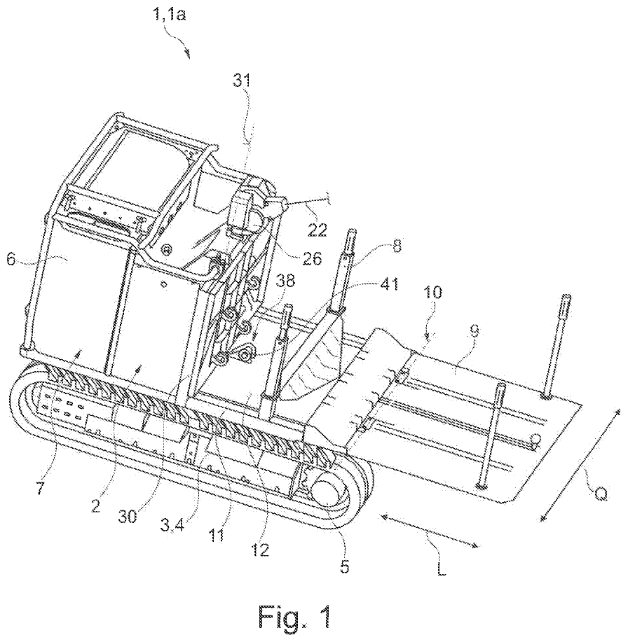

In FIG. 1, forestry equipment 1a of a system according to the disclosure with a forestry winch 2 to be tested is shown in a perspective view. The forestry equipment 1a in the illustrated exemplary embodiment is a mobile forestry machine 1, in particular a remotely controlled mobile forestry machine.

The forestry machine 1 includes a chassis 3, which is formed by tracked chassis 4, each of which is driven by a hydraulic traction drive motor 5, for example. The traction drive motors 5, seen in the longitudinal direction L of the vehicle, are each located on the respective rear end, i.e. on the stern of the vehicle, of the tracked chassis 4.

The forestry machine 1 has a hood 6, beneath which an energy supply device 7 and a forestry winch 2 are located. The forestry winch 1 also has a stanchion 8 and an adjustable ramp plate 9, which is located on the vehicle rear of a vehicle body 11 so that it can be adjusted around a horizontal transverse vehicle axis 10. The forestry machine 1 does not have a driver workplace for an operator, and can be operated remotely by an operator by means of a remote control, which is not illustrated in any further detail. The energy supply device 7 can have an internal combustion motor that drives one or more hydraulic pumps of a hydraulic system of the forestry machine 1, which supply the traction drive motors 5 and additional hydraulic consumers of the forestry machine 1.

On the front of the forestry machine 1 according to the disclosure, viewed in the longitudinal direction L of the vehicle, are the energy supply device 7, adjacent to the energy supply device 7 the forestry winch 2, adjacent to the forestry winch 2 the stanchion 8 and on the rear of the vehicle the adjustable ramp plate 9. Therefore, viewed in the longitudinal direction L, the forestry winch 2 is located between the stanchion 8 and the energy supply device 7.

The stanchion 8 is located in the vertical direction above a base plate 12 of the vehicle body 11.

The energy supply device 7 and the forestry winch 2 are located in a forward half of the forestry machine 1. The base place 12 with the stanchion 8 on it forms a rear half of the forestry machine 1.

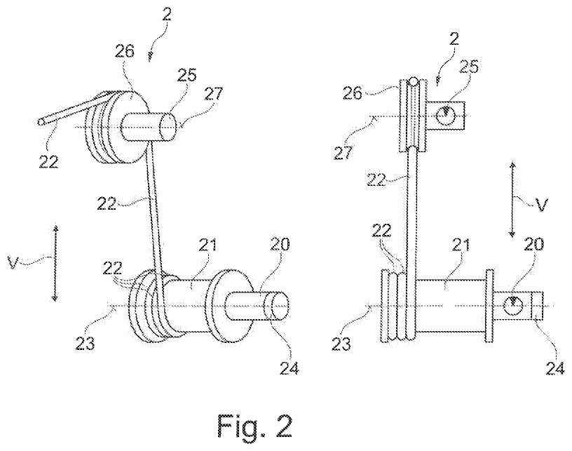

FIG. 2 shows the forestry winch 2 of the forestry equipment 1a in FIG. 1 in a schematic illustration. The illustration on the left of FIG. 2 shows a view in perspective and the illustration on the right shows a head-on view of the forestry winch 2 according to the disclosure.

The forestry winch 2 has a rope drum 21 which is driven by a drive motor 20 and on which a rope 22, for example a steel rope, is spooled. The rope drum 21 can rotate around an axis of rotation 23 and is driven by the drive motor 20. The drive motor 20 can be a hydraulic motor, for example.

The rope drum 3 of the forestry winch 2 is also in an operational connection with a brake device 24. The brake device 24 is in the form of a spring-loaded brake, for example, which is impinged by a spring device toward a braking position and by a hydraulic brake release pressure or an electromagnet toward a released position.

The forestry winch 2 also has an ejector roller 26 which can be driven by an additional drive motor 25. The ejector roller 26 is installed so that it can rotate around an axis of rotation 27. The optional drive motor 25 can be a hydraulic motor, for example.

The rope 22 is guided from the rope drum 21 in the vertical direction V to the ejector roller 26, guided over the ejector roller 26 and deflected on the ejector roller 26 so that the rope 22 is guided away from the ejector roller 26 in the horizontal direction.

The drive motor 20 of the rope drum 21 and the optional drive motor 25 of the ejector roller are connected for their energy supply with the energy supply device 7 of the forestry machine.

The ejector roller 26—as visible in FIG. 1—is located on the upper side of a vertical bulkhead 30 of the vehicle body 11 of the forestry machine 1, which extends in the transverse direction Q of the forestry machine 1 and is located between the forward half and the rear half of the forestry machine 1. In the exemplary embodiment illustrated in FIG. 1, the ejector roller 26 can pivot around a vertical pivoting axis 31 and is located on the upper side of the vertical transverse wall 30.

The rope drum 21 is located inside the hood 6.

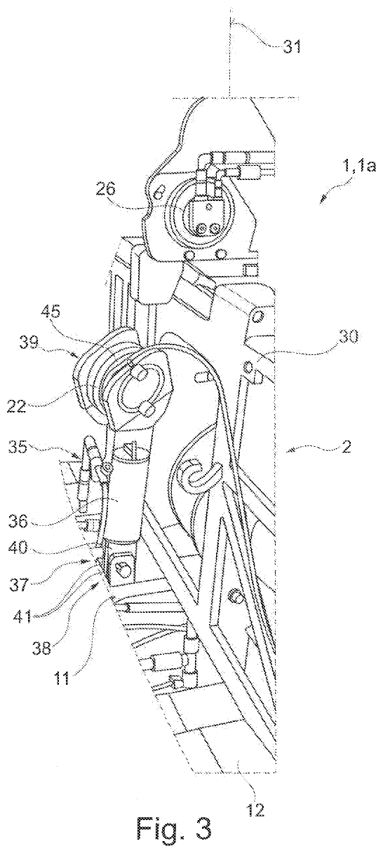

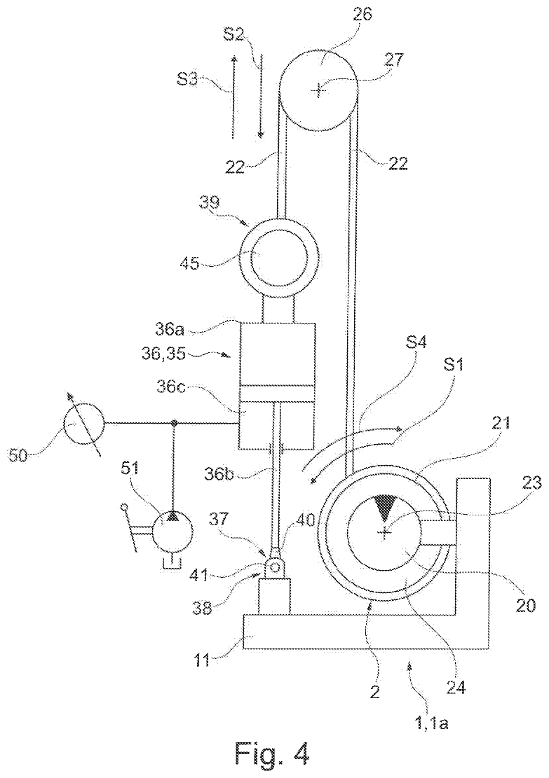

FIGS. 3 and 4 illustrate a winch testing device 35 according to the disclosure of a system according to the disclosure to test the winch pulling capacity and the brake holding capacity of the forestry winch 2 installed in the forestry equipment 1a.

The winch testing device 35 has a hydraulic test cylinder 36 which has a first attachment interface 37, with which the hydraulic test cylinder 36 can be fastened to an attachment point 38 of the forestry equipment 1a, and a second attachment interface 39 with which the hydraulic test cylinder 36 can be connected with the rope 22 of the forestry winch 2.

The first attachment interface 37 is in the form of a mounting flange 40 of a bolted connection formed on the hydraulic test cylinder 36.

The attachment point 38 of the forestry equipment 1a is located on the forestry equipment 1a vertically below the ejector roller 26.

As shown in FIGS. 1, 3 and 4, the attachment point 38 of the forestry equipment 1a is in the form of a mounting flange 41 of a bolted connection. In the illustrated exemplary embodiment, the mounting flange 41 includes two mounting flange plates at some distance from each other in the transverse direction Q of the vehicle, each of which has a boring to receive an attachment bolt. The mounting flange 40 of the hydraulic test cylinder 36 is provided by a single mounting flange plate with a boring to receive the attachment bolts which are inserted between the two mounting flange plates of the attachment point 38 and can be fastened by means of the attachment bolt to the attachment point 38.

The second attachment interface 39 is in the form of a rope attachment roller 45 located on the hydraulic test cylinder 36. In the illustrated exemplary embodiment, the rope attachment roller 45 is a wrapping knob around which the rope 22 of the forestry winch 2 can be wrapped a plurality of times, for example wrapped at least three times around the knob.

The hydraulic test cylinder 36 has a cylinder casing 36a and a piston rod 36b which is located so that it can slide in the cylinder casing 36a. A pressure chamber 36c is formed between the cylinder casing 36a and a piston located on the piston rod 36b. In the illustrated exemplary embodiment, the first attachment interface 37 is formed on the piston rod 36b and the second attachment interface 39 on the cylinder casing 36a.

Connected with the pressure chamber 36c is a pressure measuring device 50 of the winch testing device 35, with which the pressure in the pressure chamber 36c can be measured. The pressure measurement device 50 is preferably an electronic pressure measurement device that transmits the measurement data to an evaluating computer which is not illustrated in any further detail, in which the pressures measured in the pressure chamber 36a during the testing of the maximum winch pulling capacity and brake holding capacity are recorded and documented.

The winch testing device 35 also includes a hydraulic pump 51, by means of which the pressure chamber 36c can be pressurized. In the illustrated exemplary embodiment, the hydraulic pump 51 is a manually activated hand pump.

To test the winch pulling capacity and the brake holding capacity of the forestry winch 2 installed in the forestry equipment 1a in the illustrated exemplary embodiment of the mobile forestry machine 1, the hydraulic test cylinder 36 of the winch testing device 35 is fastened with the first attachment interface 37 to the attachment point 38 of the forestry equipment 1a and the rope 22, unspooled by the rope drum 21 down to the lowest rope layer, is connected with the second attachment interface 39 of the hydraulic test cylinder 36 of the winch testing device 35, so that the test of the winch pulling capacity of the forestry winch 2 and the test of the brake holding capacity of the brake device 24 of the forestry winch 2 can be performed.

To test the winch pulling capacity of the forestry winch 2, the rope drum 21 is operated by means of the drive motor 20, with the brake device 24 in the released position, in the rope spooling direction (arrow S1 in FIG. 4) and the maximum winch pulling capacity is determined by means of the winch testing device 35, i.e. the maximum rope pulling capacity that can be generated by the drive motor 20 of the rope drum 21 on the rope 22 in the rope spooling direction. A tractive force is applied to the rope 22 in the direction indicated by the arrow S3 by the rope drum 21 operated by the drive motor 20 in the rope spooling direction (arrow S1 in FIG. 4), so that the winch 2 with the rope 22 pulls against the hydraulic testing cylinder 35, as a result of which the pressure in the pressure chamber 36c increases.

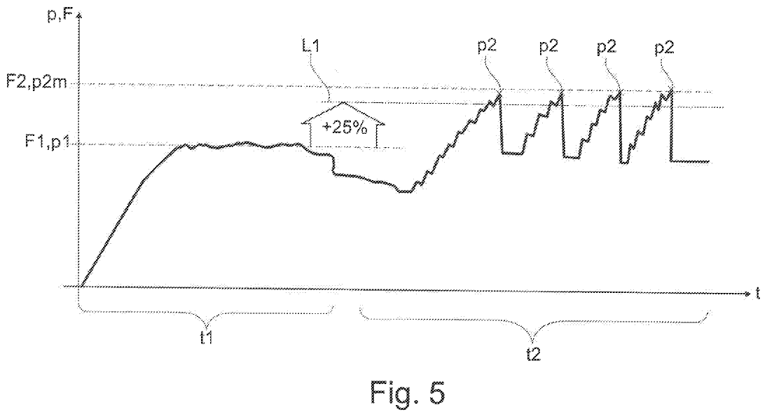

FIG. 5 illustrates the pressures in the pressure chamber 36c measured with the pressure measurement device 50 over the time t during the test of the winch pulling capacity and the test of the brake holding capacity. The winch pulling capacity (winch pulling force) F1 is measured during the time segment t1 and the brake holding capacity (brake holding force) F2 is measured during the time segment t2.

In the time segment t1 in which the winch pulling capacity F1 is measured, a pressure p1 is present in the pressure chamber 36c which corresponds to a maximum winch pulling capacity F1.

To test the brake holding capacity of the brake device 24 of the forestry winch 2, in the time segment t2, with the brake device 24 in the braking position, the brake holding capacity of the brake device 24 of the forestry winch 2 is determined by actuating the hydraulic pump 51 of the winch testing device 25.

As a result of the actuation of the hydraulic pump 51, the pressure in the pressure chamber 36c is increased, so that the hydraulic test cylinder 35 pulls on the rope 22 in the direction indicated by the arrow S2. As a result of the actuation of the hydraulic pump 51, the pressure in the pressure chamber 36 is thereby increased until the brake device 24 slips, as a result of which the rope drum 21 rotates in the rope unspooling direction (arrow S4 in FIG. 4).

FIG. 5 illustrates the individual pump strokes during the time segment t2 of the hydraulic pump 51, which produce a stepped increase of the pressure in the pressure chamber 36c and, with the asterisks, represents the respective brake holding pressures p2 at which the brake device 24 slips.

As illustrated in FIG. 5, the determination of the brake holding capacity is conducted a plurality of times, in the illustrated exemplary embodiment four-times, and from the respective brake holding pressures p2 an average value p2m is determined, or an average is determined from the respective brake holding capacities which corresponds to a brake holding capacity F2.

If the brake holding capacity F2 is at least 25% greater than the winch pulling capacity F1, i.e. the brake holding capacity F2 is at least 125% (see line L1 in FIG. 5) of the maximum winch pulling capacity F1, the forestry winch 2 meets the test requirements.

The winch test device 35 according to the disclosure, which includes only the hydraulic test cylinder 36, the hydraulic pump 51 and the pressure measurement device 50, is extremely compact and therefore mobile, so that the winch test device 35 according to the disclosure can be brought to the forestry equipment 1a to test the forestry winch 2 installed on the forestry equipment 1a. Moreover, the winch test device 35 according to the disclosure makes possible a method which, in connection with the drive motor 20 driving the rope drum 21 and the brake device 24 that brakes the rope drum 21 of the forestry equipment 1a, extremely robust, repeatable indicators of the pulling capacities and the braking capacities of the forestry winch 2 can be obtained.

For the testing of the forestry winch 2, the ejector roller 26 in the forestry equipment 1a and the attachment point 38 which is already present in the lower area for the mounting of a heavy-duty roller, are used, both of which are designed for the operational capacities of the forestry winch 2.

The vertical distance of the ejector roller 26 and of the attachment point 38 to the forestry equipment 1a is large enough that the hydraulic test cylinder 36 can be installed with the attachment interface 39 which is in the form of a rope attachment roller 45 and which makes possible the engagement of a force on the rope 22 as the rope is being is unspooled. The hydraulic test cylinder 36 with the pressure measurement device 50 performs the function of a load cell, with which on one hand the maximum winch pulling capacity F1 can be determined, and on the other hand, by means of the hydraulic pump 51, the brake holding capacity F2 which is necessary to make the brake device 24 slip can be determined.

With the winch test device 35 according to the disclosure, the maximum winch pulling capacity F1 and the brake holding capacity F2 of the forestry winch 2 can be tested directly in the forestry equipment 1a simply and easily by one tester.

The disclosure is not limited to the exemplary embodiment illustrated in the accompanying figures, in which the forestry equipment 1a is in the form of a mobile forestry machine 1. Alternatively, the forestry equipment 1a can be in the form of an accessory rear shield, for example a 3-point attachment rear shield (3-point rear shield winch), which has an installed forestry winch 2, an ejector roller 26 and an attachment point 38, and on which the vertical distance between the ejector roller 26 and the attachment point 38 on the accessory rear shield is large enough for the installation of the hydraulic test cylinder 36 with the attachment interface 39 which is in the form of a rope attachment roller 45.

The invention claimed is:

1. A winch testing device for testing a winch pulling capacity and a brake holding capacity of a forestry winch of a forestry equipment, wherein the forestry winch has a rope drum that is driven by a drive motor and braked by a brake device, and on which a rope is spooled, wherein the winch testing device comprises a hydraulic test cylinder, which has a first attachment interface with which the hydraulic testing cylinder is fastenable to an attachment point of the forestry equipment, and a second attachment interface with which the hydraulic test cylinder is configured to be connected with the rope of the forestry winch.

2. The winch testing device according to claim 1, wherein the first attachment interface is in the form of a mounting flange of a bolted connection formed on the hydraulic test cylinder.

3. The winch testing device according to claim 1, wherein the second attachment interface is in the form of a rope attachment roller located on the hydraulic test cylinder.

4. The winch testing device according to claim 1, wherein the hydraulic test cylinder has a cylinder casing and a piston rod located so that piston rod can slide in the cylinder casing, wherein the first attachment interface is located on the piston rod and the second attachment interface is located on the cylinder casing.

5. The winch testing device according to claim 1, wherein the winch testing device further comprises a pressure measuring device with which a pressure in a pressure chamber located between the cylinder casing and the piston rod can be measured.

6. The winch testing device according to claim 5, wherein the winch testing device further comprises a hydraulic pump configured to pressurize the pressure chamber.

7. The winch testing device according to claim 6, wherein the hydraulic pump is in a form of a manually actuated hand pump.

8. A forestry equipment comprising:
a forestry winch, wherein the forestry winch has a rope drum that can be driven by a drive motor and braked by a brake device, and on which a rope is spooled, wherein the rope is guided from the rope drum to an ejector roller located on the forestry equipment and is guided over the ejector roller, and
an attachment point to which a hydraulic test cylinder of a winch testing device according to claim 1 is configured to be attached.

9. The forestry equipment according to claim 8, wherein the attachment point is located vertically underneath the ejector roller.

10. The forestry equipment according to claim 8, wherein the attachment point is in a form of a mounting flange or a bolted connection.

11. A system comprising:
a forestry equipment according to claim 8 with a forestry winch, wherein the forestry winch has a rope drum that can be driven by a drive motor and braked by a brake device, and on which a rope is spooled, wherein the rope is guided from the rope drum to an ejector roller located on the forestry equipment and is guided over the ejector roller; and
a winch testing device according to claim 1 for testing a winch pulling capacity and a brake holding capacity of the forestry winch of the forestry equipment, wherein the winch testing device has a hydraulic test cylinder, which has a first attachment interface with which the hydraulic testing cylinder is fastenable to an attachment point of the forestry equipment, and a second attachment interface, with which the hydraulic test cylinder can be connected with the rope of the forestry winch, and the forestry equipment is provided with an attachment point to which the hydraulic test cylinder of the winch testing device can be attached.

12. A method for testing a rope pulling capacity and a brake holding capacity of a forestry winch of a system according to claim 11, the method comprising:
attaching a hydraulic test cylinder of a winch testing device with a first attachment interface to an attachment point of a forestry equipment;
connecting a rope of the forestry winch with a second attachment interface of a hydraulic test cylinder of the winch testing device; and
performing a test of the winch pulling capacity and performing a test of the brake holding capacity.

13. The method according to claim 12, wherein, for the testing of the winch pulling capacity, a rope drum is operated by a drive motor with a brake device in a released position in a rope spooling direction, and a maximum winch pulling capacity is determined by the winch testing device.

14. The method according to claim 12, wherein, to test the brake holding capacity, with a brake device in a braking position, the brake holding capacity is determined by actuating a hydraulic pump of the winch testing device.

15. The method according to claim 14, wherein the brake holding capacity is determined a plurality of times, and an average value of the brake holding capacity is determined.
